(19) United States
(12) Patent Application Publication
(10) Pub. No.: US 2013/0293795 A1
(43) Pub. Date: Nov. 7, 2013

(54) DISPLAY DEVICE

(71) Applicants: Takehiro Murao, Osaka-shi (JP); Hiroshi Fukushima, Osaka-shi (JP); Tomoo Takatani, Osaka-shi (JP)

(72) Inventors: Takehiro Murao, Osaka-shi (JP); Hiroshi Fukushima, Osaka-shi (JP); Tomoo Takatani, Osaka-shi (JP)

(73) Assignee: SHARP KABUSHIKI KAISHA, OSAKA (JP)

(21) Appl. No.: 13/996,958

(22) PCT Filed: Dec. 16, 2011
(86) PCT No.: PCT/JP2011/079141

§ 371 Date: Jun. 21, 2013

(30) Foreign Application Priority Data
Dec. 24, 2010 (JP) 2010-287936

(51) Int. Cl. G02B 27/22

(52) U.S. Cl. CPC G02B 27/2228
USPC 349/15

(57) ABSTRACT

A liquid crystal display device includes: a main panel that displays images; a switch panel arranged to be opposed to the main panel, the switch panel being capable of switching a mode between a two-dimensional mode that causes an image displayed on the main panel to be viewed as a two-dimensional image and a three-dimensional mode that causes the image to be viewed stereoscopically; a luminance control section that changes a luminance of the main panel upon mode switching by the switch panel; and a vision correction unit that makes luminance changes in the main panel hardly visible on a viewing side upon mode switching by the switch panel.

### TECHNICAL FIELD

The present invention relates to a display device having a switch panel that is capable of switching the display of an image between two-dimensional display and three-dimensional display.

### BACKGROUND ART

Conventionally, a display device having a switch panel that is capable of switching display of an image between two-dimensional display and three-dimensional display has been known. Such a display device includes two liquid crystal panels arranged vis-à-vis, as disclosed in, for example, JP5(1993)-122733A. The display device displays images on one of the liquid crystal panels (main panel), and displays a white-black barrier stripe image on the other liquid crystal panel (switch panel). In this configuration, the latter liquid crystal panel functions as a parallax barrier, causing the images displayed on the former liquid crystal panel to be viewed as three-dimensional stereoscopic images. It should be noted that when the barrier stripe image is not displayed on the latter liquid crystal panel, the images displayed on the former liquid crystal panel are viewed without any change, whereby the display is a two-dimensional image display.

### DISCLOSURE OF INVENTION

Incidentally, in the configuration disclosed in JP5(1993)-122733A mentioned above, when the latter liquid crystal panel (switch panel) is caused to operate so as to switch the display between the two-dimensional display and the three-dimensional display, the luminance of the display screen visible from the viewing side changes significantly. In other words, in the case of the three-dimensional display, as the barrier stripe image is displayed on the switch panel, the display screen has a luminance decreased for portions covered by the barrier stripe image. Therefore, in the case of the three-dimensional display, the luminance of the display screen viewed on the viewing side decreases as compared with the case of the two-dimensional display.

To cope with this, the following method can be thought of in order that the display screen visible from the viewing side should have a luminance at the same level in the case of the two-dimensional display and in the case of the three-dimensional display, the luminance of a light source such as a backlight is caused to decrease in the case of the two-dimensional display so as to become equal to the luminance in the case of the three-dimensional display.

In the case of such a configuration, the luminance of the light source quickly changes in response to the switching between the two-dimensional display and the three-dimensional display, but in the case where the switch panel is, for example, a liquid crystal panel, it is difficult to cause alignment states of liquid crystal molecules to abruptly change in response to the switching between the two-dimensional display and the three-dimensional display. Therefore, upon switching between the two-dimensional display and the three-dimensional display, a gap in timings of luminance changes of the light source and liquid crystal state changes, or the like, causes an unnatural luminance change in the display screen, which gives a viewer a sense of incongruity in some cases.

It is an object of the present invention to, in a display device including a switch panel that is capable of switching display of an image between two-dimensional display and three-dimensional display, prevent an unnatural luminance change that would give a viewer a sense of incongruity from occurring in a display screen upon switching between two-dimensional display and three-dimensional display.

A display device according to one embodiment of the present invention includes a main panel that displays an image; a switch panel arranged to be opposed to the main panel, the switch panel being capable of switching a mode between a two-dimensional mode that causes an image displayed on the main panel to be viewed as a two-dimensional image and a three-dimensional mode that causes the image to be viewed stereoscopically; a luminance control section that changes a luminance of the main panel upon mode switching by the switch panel; and a vision correction unit that makes luminance changes in the main panel hardly visible on a viewing side upon mode switching by the switch panel.

With the display device according to one embodiment of the present invention, an unnatural luminance change that would give a sense of incongruity to a viewer can be prevented from occurring to the display screen when the display of an image is switched between the two-dimensional display and the three-dimensional display.

### BRIEF DESCRIPTION OF DRAWINGS

FIG. 1 shows a schematic configuration of a liquid crystal display device according to Embodiment 1 of the present invention.

FIG. 2 is a cross-sectional view showing a schematic configuration of a switch panel.

FIG. 3 shows an exemplary luminance change occurring to a display screen upon switching from three-dimensional display to two-dimensional display, in the case where the screen is viewed in the normal direction.

FIG. 4 schematically shows movements of liquid crystal molecules in a liquid crystal layer upon switching from three-dimensional display to two-dimensional display.

FIG. 5 shows exemplary luminance changes occurring to a display screen upon switching from three-dimensional display to two-dimensional display, in the case where the screen is viewed in a visual angle direction.

FIG. 6 shows exemplary luminance changes occurring to a display screen upon switching from two-dimensional display to three-dimensional display, in the case where the screen is viewed in the normal direction.

FIG. 7 is a block diagram showing a schematic configuration of a vision correction unit in the liquid crystal display device according to Embodiment 1.

FIG. 8 shows exemplary luminance of a backlight corrected by luminance correction performed by the vision correction unit.

FIG. 9 shows exemplary luminance of the display screen after the luminance correction.

FIG. 10 is a block diagram showing a schematic configuration of the vision correction unit according to a modification example of Embodiment 1.

FIG. 11 is a block diagram showing a schematic configuration of a vision correction unit of a liquid crystal display device according to Embodiment 2.

FIG. 12 schematically shows an exemplary case where a luminance change in a display screen due to a liquid crystal response delay is hidden by black display of the screen.

FIG. 13 is a block diagram showing a schematic configuration of a vision correction unit in a liquid crystal display device according to Embodiment 3.

FIG. 14 shows an exemplary case where a luminance change in a display screen due to a liquid crystal response delay is hidden by backlight luminance adjustment.

FIG. 15 is a cross-sectional view showing a schematic configuration of a switch panel of the display device according to Embodiment 3.

### DESCRIPTION OF THE INVENTION

A display device according to one embodiment of the present invention includes a main panel that displays an image; a switch panel arranged to be opposed to the main panel, the switch panel being capable of switching a mode between a two-dimensional mode that causes an image displayed on the main panel to be viewed as a two-dimensional image and a three-dimensional mode that causes the image to be viewed stereoscopically; a luminance control section that changes a luminance of the main panel upon mode switching by the switch panel; and a vision correction unit that makes luminance changes in the main panel hardly visible on a viewing side upon mode switching by the switch panel (the first configuration).

In the above-described configuration, when the mode is switched by an operation of the switch panel between the two-dimensional mode and the three dimensional mode, the luminance of the main panel is switched by the luminance control section, and at the same time, luminance changes therein can be made hardly visible on the viewing side by the vision correction unit. Therefore, this makes it possible to switch the display between the two-dimensional display and the three-dimensional display, without giving a sense of incongruity to a viewer.

Here, the “luminance” means a light intensity per unit surface area of a light emitter when the light emitter is viewed. More specifically, in the case where the main panel itself emits light, the “luminance of the main panel” means a light intensity per unit surface area of the main panel when the main panel is viewed. On the other hand, in the case where there is provided a light source apart from the main panel, the “luminance of the main panel” means a light intensity per unit surface area of the main panel when a display surface of the main panel is viewed. Further, the “luminance of the display screen” means a light intensity per unit surface area of the screen positioned outermost on the viewing side when the display screen of the display device is viewed.

In the first configuration described above, preferably, the vision correction unit is configured to change the luminance of the main panel, so as to make luminance changes in the main panel hardly visible from the viewing side upon mode switching by the switch panel (the second configuration).

By causing the vision correction unit to change the luminance of the main panel in this way, it is possible to prevent luminance changes in the display screen that would give a sense of incongruity from being viewed by a viewer, upon the switching between the two-dimensional display and the three-dimensional display.

In the second configuration described above, preferably, the display device further includes a light source section for emitting light to the main panel, wherein the vision correction unit is configured to change a luminance of the light source section (the third configuration). This makes it possible to prevent luminance changes in the display screen that would give a sense of incongruity from being viewed by a viewer, upon the switching between the two-dimensional display and the three-dimensional display. Here, the “luminance of the light source section” means a light intensity per unit surface area when the light source section is viewed.

In the second or third configuration described above, preferably, the vision correction unit is configured to adjust the luminance of the main panel so as to cause a display screen viewed from the viewing side to have a constant luminance upon mode switching by the switch panel (the fourth configuration).

This makes constant the luminance of the display screen viewed on the viewing side upon the mode switching by the switch panel, thereby allowing the switching between the two-dimensional display and the three-dimensional display to be performed without giving a sense of incongruity.

In any one of the second to fourth configurations described above, preferably, the vision correction unit includes: a temperature detection part that detects an ambient temperature; a correction value storage part in which a correction value for correcting the luminance of the main panel according to the ambient temperature is stored; and a luminance correction section that, according to the ambient temperature detected by the temperature detection part, reads out the correction value stored in the correction value storage part, and corrects the luminance of the main panel by using the correction value (the fifth configuration).

In the case where the switch panel is a liquid crystal panel, characteristics thereof vary with the ambient temperature, but the above-described configuration allows appropriate luminance correction to be performed against such variation of characteristics as well. In the correction value storage part, luminance correction values corresponding to ambient temperatures are stored. Therefore, a correction value corresponding to an ambient temperature can be read out of the correction value storage part and the luminance of the main panel can be corrected by the luminance correction section. This makes it possible to make luminance changes in the display screen upon the switching between the two-dimensional display and the three-dimensional display hardly visible on the viewing side. Therefore, the switching between the two-dimensional display and the three-dimensional display can be performed without giving a sense of incongruity to a viewer.

In any one of the second to fourth configurations described above, preferably, the vision correction unit includes: a luminance detection part that detects a luminance of the display screen on the viewing side; and a luminance adjustment part that adjusts the luminance of the main panel based on the luminance detected by the luminance detection part (the sixth configuration).

This allows the luminance of the main panel to be adjusted according to the luminance of the display screen on the viewing side, thereby making luminance changes in the display screen upon the switching between the two-dimensional display and the three-dimensional display hardly visible to a viewer. Therefore, the switching between the two-dimensional display and the three-dimensional display can be performed without giving a sense of incongruity to a viewer.

In the first configuration described above, preferably, the vision correction unit is configured to change a gray scale level of an image displayed on the main panel, so as to make luminance changes in the main panel hardly visible from the viewing side (the seventh configuration). This makes it possible to prevent luminance changes in the display screen that would give a sense of incongruity from being viewed by a viewer upon the switching between the two-dimensional display and the three-dimensional display.

In any one of the second, third, and sixth configurations described above, preferably, the vision correction unit is configured to turn the display screen into a black state upon mode switching by the switch panel, so as to make luminance changes in the main panel invisible from the viewing side (the eighth configuration).

This allows the display screen to turn into the black display state (black state) upon the switching between the two-dimensional display and the three-dimensional display by the switch panel, thereby making it possible to prevent unnatural luminance changes in the display screen upon the switching between the two-dimensional display and the three-dimensional display from being viewed by a viewer. Therefore, it is possible to perform the switching between the two-dimensional display and the three-dimensional display without giving a sense of incongruity to a viewer.

Here, the “black state” encompasses, not only a dark state with a luminance of the display screen being almost zero, but also a state with such a small luminance that luminance changes in the display screen upon the switching between the two-dimensional display and the three-dimensional display are invisible.

In the eighth configuration described above, preferably, the vision correction unit is configured to, when turning the display screen into the black state, gradually decrease the luminance of the main panel to turn the display screen into the black state, and thereafter gradually increase the luminance of the main panel (the ninth configuration).

This configuration allows the display screen to be turned into the black state with a much smaller sense of incongruity, upon the switching between the two-dimensional display and the three-dimensional display by the switch panel, thereby allowing the switching between the two-dimensional display and the three-dimensional display to be performed with a much smaller sense of incongruity.

In any one of the first to ninth configuration described above, preferably, the switch panel includes a liquid crystal layer, and a pair of electrodes arranged so that the liquid crystal layer is interposed between the electrodes (the tenth configuration).

In the case where the switch panel is a liquid crystal panel as in the above-described case, unnatural luminance changes tend to be viewed in the display screen upon the switching between the two-dimensional display and the three-dimensional display, due to liquid crystal response delays. Therefore, by applying such a configuration as the first to ninth configurations described above, it is possible to prevent unnatural luminance changes in the screen display upon the switching between the two-dimensional display and the three-dimensional display from being viewed by a viewer.

In the tenth configuration described above, preferably, when a voltage is applied to the pair of electrodes of the switch panel, the liquid crystal layer of the switch panel functions as a liquid crystal lens (the eleventh configuration). In the case where the switch panel functions as a liquid crystal lens in this way, the liquid crystal layer is thicker, and therefore, luminance changes resulting from liquid crystal response delays upon the switching between the two-dimensional display and the three-dimensional display become more conspicuous. Therefore, such a configuration as the first to ninth configurations may be applied to this configuration, whereby more remarkable effects can be achieved.

Hereinafter, preferred embodiments of the display device of the present invention are explained with reference to the drawings. It should be noted that the dimensions of the constituent members shown in the drawings do not faithfully reflect actual dimensions of the constituent members, dimensional ratios of the constituent members, etc.

### Embodiment 1

### (Overall Configuration)

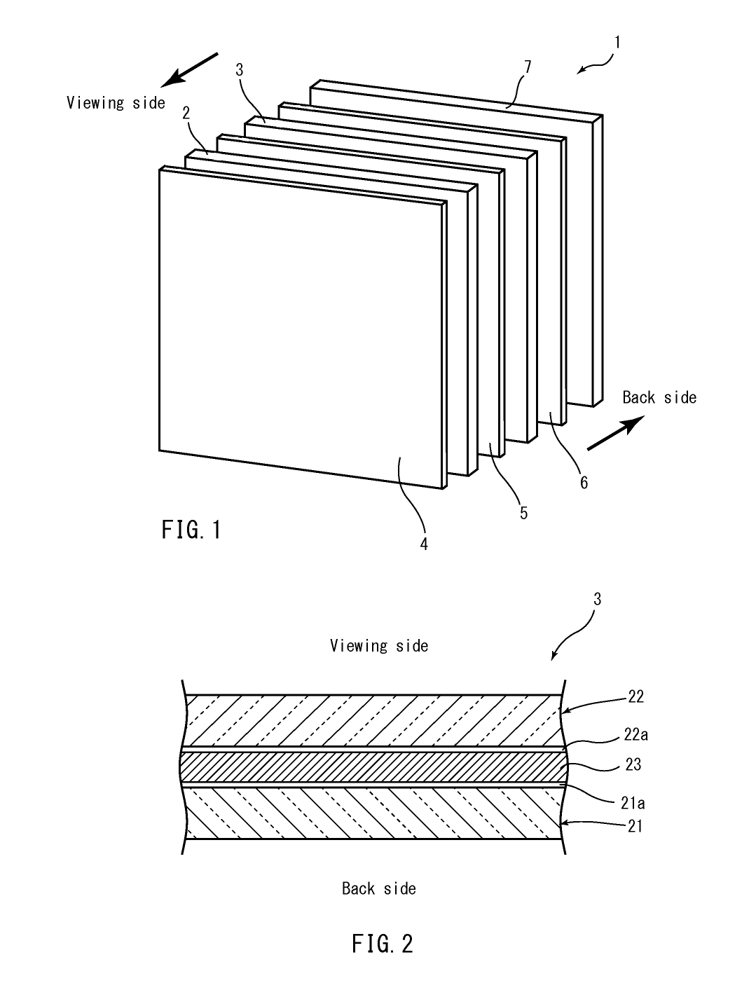

FIG. 1 shows a schematic configuration of a liquid crystal display device 1 (display device) according to one embodiment of the present invention. This liquid crystal display device 1 is formed by laminating a plurality of members in the thickness direction. More specifically, the liquid crystal display device 1 includes a main panel 2 that displays images, a switch panel 3 that displays a slit-form black-white image (stripe image), and three polarizing plates 4, 5, and 6 that are arranged so that the main panel 2 and the switch panel 3 are interposed therebetween. Further, the liquid crystal display device 1 includes a backlight 7.

As shown in FIG. 1, in the liquid crystal display device 1, the following are laminated in the stated order from the viewing side (the front side of FIG. 1): the polarizing plate 4; the main panel 2; the polarizing plate 5; the switch panel 3; the polarizing plate 6; and the backlight 7 (light source section). In the liquid crystal display device 1 according to the present embodiment, the polarizing plate 5 functions as both of the polarizing plate arranged on the back side of the main panel 2 and the polarizing plate arranged on the viewing side of the switch panel 3. It should be noted that as the backlight 7, for example, the following can be used: a direct backlight; an edge light type backlight; and a planar light source type backlight. As a light source for the backlight 7, for example, a cathode ray tube, a light-emitting diode (LED), or the like can be used.

The liquid crystal display device 1 according to the present embodiment is a three-dimensional image display device of a so-called parallax barrier type, which displays a stripe image on the switch panel 3 to form a parallax barrier, so as to cause a right-eye image among images displayed on the main panel 2 to become visible only to the right eye, and cause a left-eye image among them to become visible only to the left eye. Therefore, the main panel 2 displays the left-eye image and the right-eye image on one screen in synchronization with the display of the stripe image on the switch panel 3. It should be noted that in the case where the liquid crystal display device 1 according to the present embodiment is used as a display device for displaying two-dimensional images, the display of the switch panel 3 is stopped, and the switch panel 3 is made transparent. In other words, the switch panel 3 is configured so that its mode can be switched between the three-dimensional mode for displaying an image on the main panel 2 as a three-dimensional image and the two-dimensional mode for displaying the image as a two-dimensional image.

The main panel 2 is, for example, a VA (vertical alignment)-type liquid crystal panel. The main panel 2 includes an active matrix substrate on which a multiplicity of pixels are arranged in matrix, and a counter substrate arranged so as to be opposed to the active matrix substrate, though they are not shown in the drawing specifically. Further, the main panel 2 includes a liquid crystal layer between the active matrix substrate and the counter substrate, the liquid crystal layer being switchable between a state of causing birefringence of light and a state of transmitting light. It should be noted that the main panel 2 may be a liquid crystal panel other than the VA type.

The active matrix substrate has such a configuration that a plurality of TFTs (thin film transistors, not shown), pixel electrodes, a plurality of lines (source lines, gate lines, etc.), and the like are formed on a transparent substrate such as a glass substrate. It should be noted that detailed explanation of the TFTs is omitted since the TFTs are the same as conventional ones.

The pixel electrodes are transparent electrodes, and are formed with a conductive material having light transmissivity such as ITOs (indium tin oxide). The pixel electrodes are arranged pixel by pixel, separated from one another. Pixels as units of image display are defined by these pixel electrodes.

Source electrodes, gate electrodes, and drain electrodes of the TFTs are connected to the source lines, the gate lines, and the pixel electrodes, respectively, though they are not shown specifically. The configuration in which signals are input to the TFTs via the gate lines and the source lines so as to drive the TFTs is the same as that for a conventional liquid crystal display device, and detailed explanation of the same is omitted herein.

The counter substrate has such a configuration that a counter electrode made of a transparent conductive film made of ITO or the like is provided on a transparent substrate such as a glass substrate. Besides, on the counter substrate, color filters of RGB are provided.

In the main panel 2 having a configuration as described above, the state of the liquid crystal layer can be switched pixel by pixel between the state of transmitting light and the state of causing birefringence of light, by controlling electric fields applied to the liquid crystal layer, that is, by controlling voltages applied across the counter electrode and the pixel electrodes. In other words, the application of electric fields to the liquid crystal layer is controlled by the TFTs, whereby areas that are colored by the color filters with light transmitted through light transmission regions in the liquid crystal layer are displayed as a color image.

It should be noted that in the present embodiment, the color filters are provided on the counter substrate, but the configuration is not limited to this. The configuration may be without color filters.

The switch panel 3 is, for example, a TN (twisted nematic)-type liquid crystal panel. Thus the switch panel 3 is a TN-type liquid crystal panel, thereby being capable of causing the stripe image on the switch panel 3 to be displayed at a higher contrast, as compared with a liquid crystal panel of another type. Therefore, with the liquid crystal display device 1 according to the present embodiment, it is possible to display a three-dimensional image with higher display quality.

The switch panel 3 includes a substrate 21 on which electrodes are formed in slit-like form, and a counter substrate 22 arranged so as to be opposed to the substrate 21 (see FIG. 2). Further, the switch panel 3 includes a liquid crystal layer 23 whose state can be switched between a state of rotating light and a state of transmitting light, between the substrate 21 and the counter substrate 22. It should be noted when that, in the switch panel 3, regions that assume the state of transmitting light are formed in a stripe form in the liquid crystal layer 23, the three-dimensional mode is realized. On the other hand, in the switch panel 3, when light is rotated in all regions of the liquid crystal layer 23, which causes the switch panel 3 to become transparent, the two-dimensional mode is realized.

Further, on the liquid crystal layer 23 side surfaces of the substrate 21 and the counter substrate 22, alignment films 21a and 22a are provided, respectively. These alignment films 21a and 22a have been subjected to a rubbing treatment of rubbing surfaces thereof in one direction with cloth or the like. By applying the rubbing treatment to these alignment films 21a and 22a, liquid crystal molecules in the liquid crystal layer 23 can be aligned in one certain direction. In the present embodiment, the alignment films 21a and 22a of the substrate 21 and the counter substrate 22 are rubbed in such a manner that the rubbing direction for the alignment film 21a provided on the substrate 21 and the rubbing direction for the alignment film 22a provided on the counter substrate 22 are deviated from each other at approximately 90 degrees as viewed from the viewing side.

This causes liquid crystal molecules in the liquid crystal layer 23 to be arranged in a twisted state so that the alignment direction of liquid crystal molecules on the substrate 21 side and the alignment direction of liquid crystal molecules on the counter substrate 22 side have an angle difference of 90 degrees therebetween. As a result, the switch panel 3 functions as a TN-type liquid crystal panel.

It should be noted that the configuration of the substrate 21 of the switch panel 3 is not limited to the above-described configuration, and may be any configuration as long as a stripe image can be displayed on the switch panel 3. It may be any configuration, for example, an active matrix substrate on which a multiplicity of pixels are arranged in matrix.

### (Luminance Correction)

In the liquid crystal display device 1 having the above-described configuration, in the case where images on the main panel 2 are caused to be viewed as a three-dimensional image, a stripe image is caused to be displayed on the switch panel 3, so that a right-eye image is made visible only to the right eye, and a left-eye image is made visible only to the left eye, as described above. In this state, a part of light from the backlight 7 is blocked by the stripe image displayed on the switch panel. This causes the luminance of the main panel 2 when viewed from the viewing side to decrease as compared with the case where the stripe image is not displayed on the switch panel 3. In other words, when viewed from the viewing side, the luminance of the display screen (the screen positioned outermost on the viewing side) of the liquid crystal device is smaller in the case of the three-dimensional display as compared with the case of the two-dimensional display. Therefore, when the display of images of the liquid crystal display device is switched between the two-dimensional display and the three-dimensional display, the luminance of the display screen changes, which gives a sense of incongruity to a viewer, in some cases.

To address this, the following configuration can be proposed: in the case where the display of images of the liquid crystal display device is in the two-dimensional display mode, the luminance of the backlight 7 is decreased so that the luminance of the display screen in this case is at the same level as the luminance of the display screen in the case of the three-dimensional display when viewed from the viewing side. This allows the luminance in the case of the two-dimensional display and the luminance in the case of the three-dimensional display to be at the same level, which makes it possible to prevent a significant sense of incongruity from being given to a viewer upon switching between the two-dimensional display and the three-dimensional display.

Incidentally, the luminance of the backlight 7 is changed during the two-dimensional display as described above, the luminance of the backlight 7 changes almost simultaneously upon the switching between the two-dimensional display and the three-dimensional display. On the other hand, as there are time lags in movements of liquid crystal molecules in the switch panel 3, the alignment of the liquid crystal of the switch panel 3 does not change instantly. Particularly, in the switch panel 3 formed with TN liquid crystal, when the switch panel 3 is switched from the three-dimensional mode to the two-dimensional mode, in other words, when the electric field applied to the switch panel 3 is nullified, a phenomenon called the backflow phenomenon, which is to be described later, occurs. This causes the liquid crystal molecules to sway when the liquid crystal molecules are re-aligned, resulting in that the luminance of the main panel 2 significantly fluctuates several times. It should be noted that the fluctuations of the luminance of the main panel 2 appears as luminance changes in the display screen on the viewing side, and therefore, the fluctuations are explained as luminance changes in the display screen in the following description.

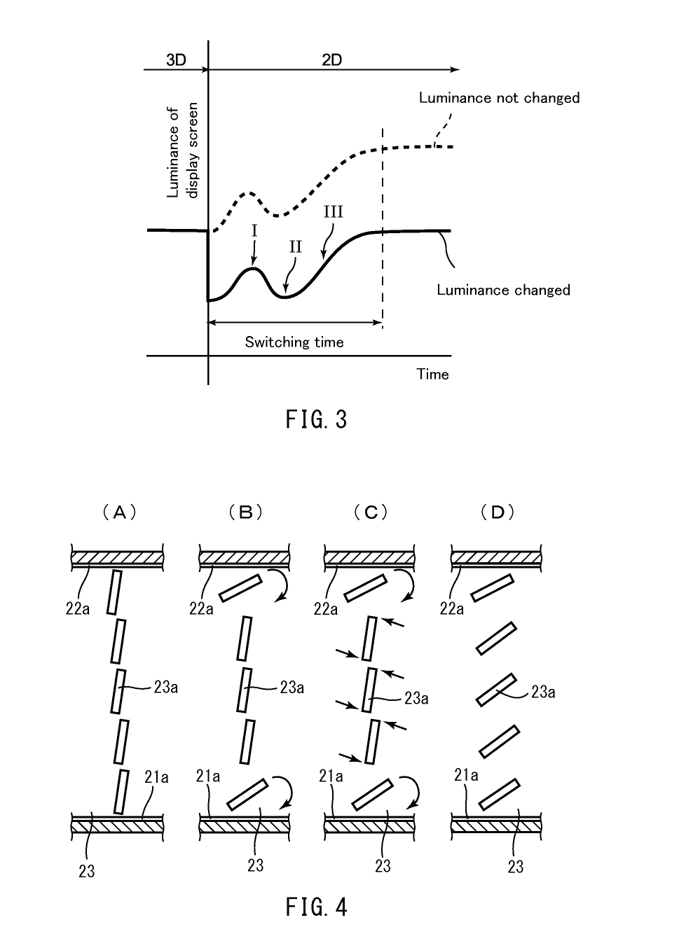

Exemplary luminance changes in the display screen when the display is switched from the three-dimensional display to the two-dimensional display are shown in FIG. 3. As is clear from FIG. 3, upon switching from the three-dimensional display (denoted by “3D” in the drawing, and in the following explanation as well) to the two-dimensional display (denoted by “2D” in the drawing, and in the following explanation as well), the luminance of the display screen increases (indicated by the broken line in the drawing) in the case where the luminance of the backlight 7 is not changed. To cope with this, the luminance of the display screen in the case of the three dimensional display and that in the case of the two-dimensional display can be made at the same level by changing the luminance of the backlight 7 (indicated by the solid line in the drawing). However, even with a change in the luminance of the backlight 7, the luminance of the display screen significantly fluctuates, since liquid crystal molecules sway due to the backflow phenomenon occurring upon the mode switching of the switch panel 3. It should be noted that such fluctuations of the luminance of the display screen due to the backflow phenomenon occur, irrespective of whether or not the luminance of the backlight 7 changes.

Here, the above-described backflow phenomenon is explained in detail, with reference to FIGS. 3 and 4. As shown in (A) of FIG. 4, when an electric field is applied to the liquid crystal layer 23, the liquid crystal molecules 23a are in a state of erecting in the liquid crystal layer 23 (the major axis direction of the liquid crystal molecules 23a matches the thickness direction of the liquid crystal layer 23). Here, in the vicinities of the alignment films 21a and 22a, as angles formed between the alignment films 21a and 22a and the liquid crystal molecules 23a increase, the twist energy increases. Therefore, when the electric field applied to the liquid crystal layer 23 is nullified, as shown in (B) of FIG. 4, the liquid crystal molecules 23a in the vicinities of the alignment films 21a and 22a attempt to become re-aligned instantly upon the nullification of the electric field, causing a significant flow of liquid crystal to occur therearound (the luminance of the display screen upon this is denoted by “I” in FIG. 3). As shown in (C) of FIG. 4, with this, movements of re-alignment of the liquid crystal molecules 23a in the vicinities of the alignment films 21a and 22a cause liquid crystal molecules 23a that are positioned in the liquid crystal layer 23 and have not yet started moving to move in a direction opposite to a direction in which they go back to the original alignment (the state shown in (D) of FIG. 4). As a result, as denoted by “II” in FIG. 3, the transmittance of the liquid crystal layer 23 rapidly goes down and the luminance of the display screen decreases. Thereafter, the liquid crystal molecules 23a in the liquid crystal layer 23 gradually return to the original alignment (the state shown in (D) of FIG. 4), and accordingly the bounding of the transmittance gradually ends, whereby the transmittance of the liquid crystal layer 23 is stabilized and the luminance of the display screen becomes constant (denoted by “III” in FIG. 3).

It should be noted that the liquid crystal molecules 23a are arranged so as to be gradually twisted in the thickness direction of the liquid crystal layer 23 as viewed in the viewing direction, as described above, but in FIG. 4, the liquid crystal molecules 23a are shown with the illustration of twist thereof being omitted, for the sake of simplification of the drawing.

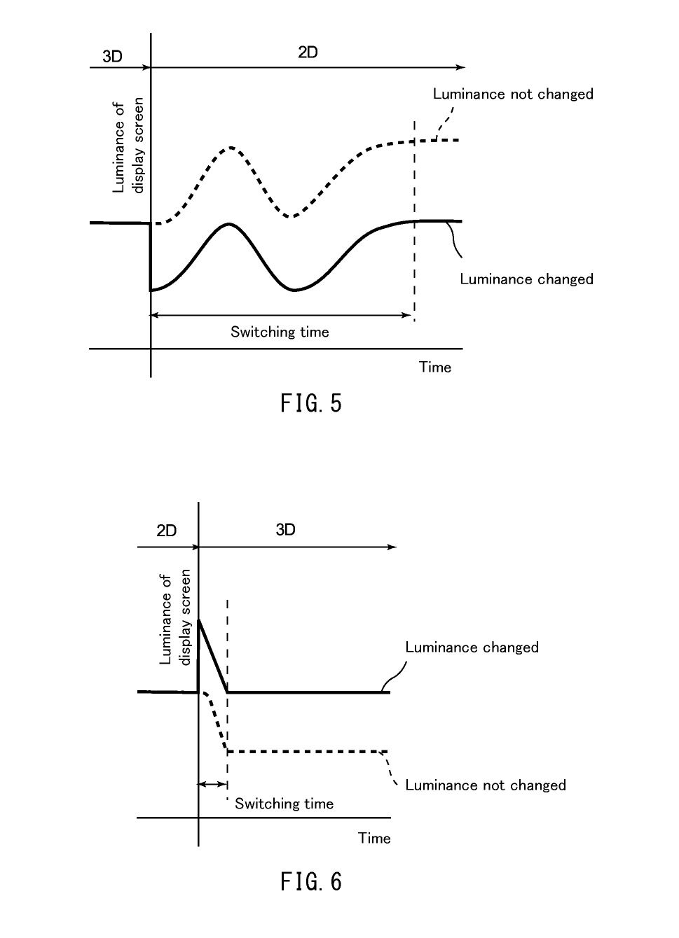

The luminance changes shown in FIG. 3 described above are examples when being viewed in the normal direction with respect to the screen. Luminance changes in the display screen when viewed in the visual angle direction on the viewing side (in the present embodiment, let the direction toward the top side of the screen be the 0 o'clock direction and let the direction toward the bottom side of the screen be the 6 o'clock direction as viewed from the viewing direction, then, the foregoing direction is equivalent to the 6 o'clock direction) are shown in FIG. 5. It should be noted that the 6 o'clock direction is regarded as the visual angle direction in the present embodiment, but the visual angle direction varies with the rubbing direction of the switch panel 3.

Thus, the luminance of the display screen varies with the direction in which the screen of the liquid crystal display device is viewed, but in the following explanation, let the point of view for viewing three-dimensional images be the point of view in the case where the center of the screen of the liquid crystal display device is viewed in the normal direction, and the explanation is made with reference to an exemplary case of this point of view. It should be noted that the point of view for viewing three-dimensional images may be a point other than that in the case where the center of the screen is viewed in the normal direction, and luminance correction that will be described later may be made at, not only the point of view for three-dimensional images, but also another point of view.

It should be noted that, as described above, luminance changes in the display screen are influenced significantly by behaviors of the liquid crystal molecules 23a of the switch panel 3. Therefore, the luminance of the display screen significantly varies with the ambient temperature (the temperature around the liquid crystal display device 1), which influences behaviors of the liquid crystal molecules 23a. Therefore, luminance changes in the display screen shown in FIGS. 3 and 5 vary, influenced by the ambient temperature. It should be noted that the cases shown in FIGS. 3 and 5 are cases when the ambient temperature is 25° C.

Further, the backflow phenomenon as described above occurs only when the electric fields applied to the switch panel 3 are nullified, that is, when the display of images is switched from the three-dimensional display to the two-dimensional display. When the display of images is switched from the two-dimensional display to the three-dimensional display as well, however, the luminance of the display screen fluctuates as shown in FIG. 6, since the liquid crystal molecules move slow with respect to a luminance change of the backlight 7. It should be noted that FIG. 6 shows exemplary luminance changes at the above-described point of view for three-dimensional images.

As is clear from FIG. 6, in the case where the display is switched from the two-dimensional display to the three-dimensional display, the backflow phenomenon like that in the case where the display is switched from the three-dimensional display to the two-dimensional display (FIGS. 3 and 5) does not occur, and a switching time is considerably short as compared with the case of the switching from the three-dimensional display to the two-dimensional display. When the display is switched from the three-dimensional display to the two-dimensional display, the electric fields applied to the liquid crystal are nullified so that liquid crystal molecules are allowed to naturally return to their original alignment state; in contrast, when the display is switched from the two-dimensional display to the three-dimensional display, electric fields are applied to liquid crystal so as to control the alignment of liquid crystal molecules, which results in that liquid crystal switches within a shorter time.

As described above, upon switching between the two-dimensional display and the three-dimensional display, the luminance of the display screen, viewed from the viewing side, significantly fluctuates, which gives a sense of incongruity to a viewer in some cases. In the present embodiment, the luminance is corrected upon switching between the two-dimensional display and the three-dimensional display, so that no luminance change that gives a sense of incongruity should occur on the display screen.

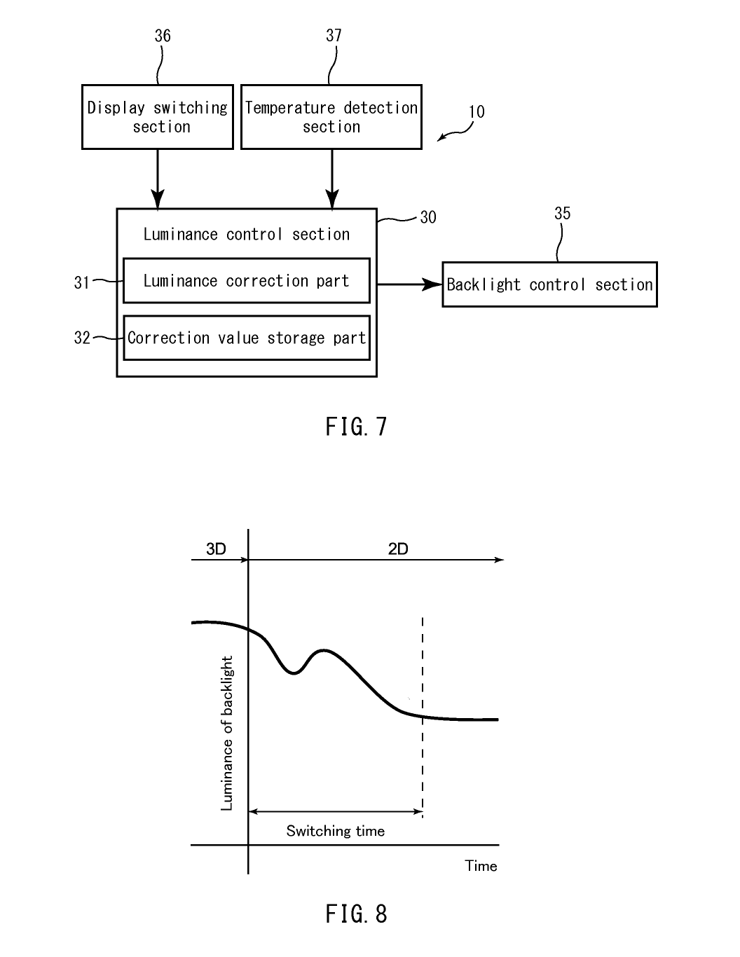

As shown in FIG. 7, the liquid crystal display device 1 includes a luminance control section 30 that controls the luminance of the main panel 2, and a backlight control section 35 that controls the luminance of the backlight 7 in response to a control signal that is output from the luminance control section 30. Further, the liquid crystal display device 1 includes a display switching section 36 that outputs a signal to the luminance control section 30 upon switching between the two-dimensional display and the three-dimensional display, and a temperature detection section 37 that detects an ambient temperature of the liquid crystal display device 1 and outputs a signal to the luminance control section 30.

When a signal indicating that the switching between the two-dimensional display and the three-dimensional display is performed is output from the display switching section 36, the luminance control section 30 outputs a control signal to the backlight control section 35, the control signal being a signal for changing the luminance of the backlight 7. More specifically, when a signal indicating that the switching of the display to the three-dimensional display is performed is input from the display switching section 36 to the luminance control section 30, the luminance control section 30 outputs a control signal for causing the luminance of the backlight 7 to increase. On the other hand, when a signal indicating that the switching of the display to the two-dimensional display is performed is input from the display switching section 36 to the luminance control section 30, the luminance control section 30 outputs a control signal for causing the luminance of the backlight 7 to decrease. Accordingly, the luminance control section 30 can change the luminance of the main panel 2.

Further, the luminance control section 30 includes a luminance correction part 31 that outputs a correction signal for correcting the luminance of the backlight 7, and a correction value storage part 32 in which luminance correction values corresponding to ambient temperatures detected by the temperature detection section 37 are stored. The luminance correction part 31 is configured to read out a luminance correction value corresponding to an ambient temperature detected by the temperature detection section 37, from the correction value storage part 32, and output the same as a control signal to the backlight control section 35. The luminance correction part 31 and the correction value storage part 32, together with the temperature detection section 37, compose a vision correction unit 10. It should be noted that the foregoing vision correction unit 10 may include other members than the luminance correction part 31, the correction value storage part 32, and the temperature detection section 37.

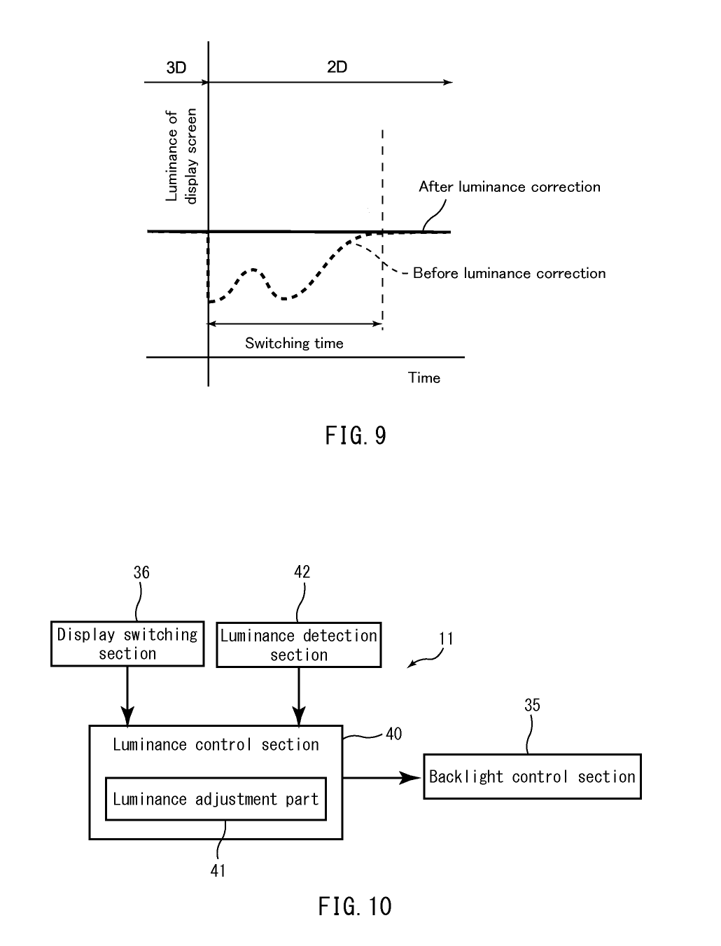

The correction values stored in the correction value storage part 32 are values (or functions) that would almost nullify luminance changes in the display screen (luminance changes in the main panel 2) that result from operation characteristics of liquid crystal at respective temperatures, when the screen is viewed in the normal direction with respect to the screen (FIG. 3), for example. An exemplary case where the luminance of the backlight 7 is corrected by using such a correction value is shown in FIG. 8. The luminance of the backlight 7 shown in FIG. 8 is set to values that would cause luminance changes in the display screen indicated by the broken line shown in FIG. 9 to be corrected so that constant luminance indicated by the solid line shown in FIG. 9 should be achieved. Accordingly, by using correction values that would cause the luminance of the backlight 7 to become the luminance as shown in FIG. 8, luminance changes in the display device can be almost nullified (constant luminance), as indicated by the solid line in FIG. 9. In the example shown in FIGS. 8 and 9, the correction values are set so that the luminance changes in the display screen upon the switching from the three-dimensional display to the two-dimensional display are almost nullified, but the configuration is not limited to this. The correction values may be set so that luminance changes in the display screen should decrease as compared with the case shown in FIG. 3.

It should be noted that the correction values (or functions) stored in the correction value storage part 32 may be values that would almost nullify the luminance changes in the display screen when the screen is viewed from another direction with respect to the screen, or alternatively, values that cause the luminance changes in the display screen when the screen is viewed in a plurality of directions to decrease.

When a control signal is input from the luminance control section 30, the backlight control section 35 controls the backlight 7 so that the luminance of the backlight 7 should change. More specifically, for example, in the case where the backlight 7 is composed of LEDs, the backlight control section 35 controls the current supplied to the LEDs so as to control the luminance of the backlight 7. It should be noted that, as described above, the backlight 7 may have any of various configurations, and the method for controlling the backlight 7 therefore is not limited to the above-described method.

### Effect of Embodiment 1

As described above, in the present embodiment, the luminance of the backlight 7 is changed so that the luminance changes in the display screen upon the switching between the two-dimensional display and the three-dimensional display should decrease in both of the case of the two-dimensional display and the case of the three-dimensional display. This makes it possible to prevent the luminance of the main panel 2 and the display screen from becoming different between the case of the two-dimensional display and the three-dimensional display.

Further, in the present embodiment, upon the switching between the two-dimensional display and the three-dimensional display, the luminance of the backlight 7 is corrected according to the ambient temperature. This makes it possible to, even when characteristics of the liquid crystal of the switch panel 3 have changed according to the ambient temperature, cause the luminance of the light 7 to change according to the changes of the characteristics. Therefore, it is possible to more surely decrease luminance changes in the display screen upon the switching between the two-dimensional display and the three-dimensional display. Therefore, it is possible to prevent a sense of incongruity from being given to a viewer upon the switching between the two-dimensional display and the three-dimensional display.

### Modification Example of Embodiment 1

FIG. 10 shows a modification example of Embodiment 1. This modification example has a configuration that is different from the above-described configuration of Embodiment 1 in the point that the correction of luminance is performed according to the luminance of the display screen. In the following explanation, portions having the same configurations as those in Embodiment 1 are denoted by the same reference numerals as those in Embodiment 1, and portions that are different from those in Embodiment 1 are explained in the following description.

Specifically, the liquid crystal display device includes a luminance control section 40, a backlight control section 35, a display switching section 36, and a luminance detection section 42. The luminance control section 40 is configured so as to control the luminance of the backlight 7 according to the switching between the two-dimensional display and the three-dimensional display. In addition, the luminance control section 40 further includes a luminance adjustment part 41 that adjusts the luminance of the backlight 7 according to the luminance of the display screen detected by the luminance detection section 42. This luminance adjustment part 41 uses the luminance of the display screen in the case of the two-dimensional display as a target value, and generates a correction signal so as to cause the luminance of the display screen detected by the luminance detection section 42 to become approximately equal to the target value. This correction signal is output to the backlight control section 35. Thus, the luminance of the backlight 7 is adjusted by the backlight control section 35.

The luminance detection section 42 is composed of, for example, photosensors provided on the viewing side of the liquid crystal display device. Further, this luminance detection section 42 is provided at a position at which it can detect a luminance of the display screen on the viewing side in the liquid crystal display device. A vision correction unit 11 is composed of the luminance adjustment part 41 and the luminance detection section 42. It should be noted that the vision correction unit 11 may include other members than the luminance adjustment part 41 and the luminance detection section 42.

Thus, by controlling the luminance of the backlight 7 according to the luminance of the screen on the viewing side, luminance changes in the display screen that occur upon the switching between the two-dimensional display and the three-dimensional display can be decreased. This makes it possible to prevent a sense of incongruity from being given to a viewer upon the switching between the two-dimensional display and the three-dimensional display.

### Embodiment 2

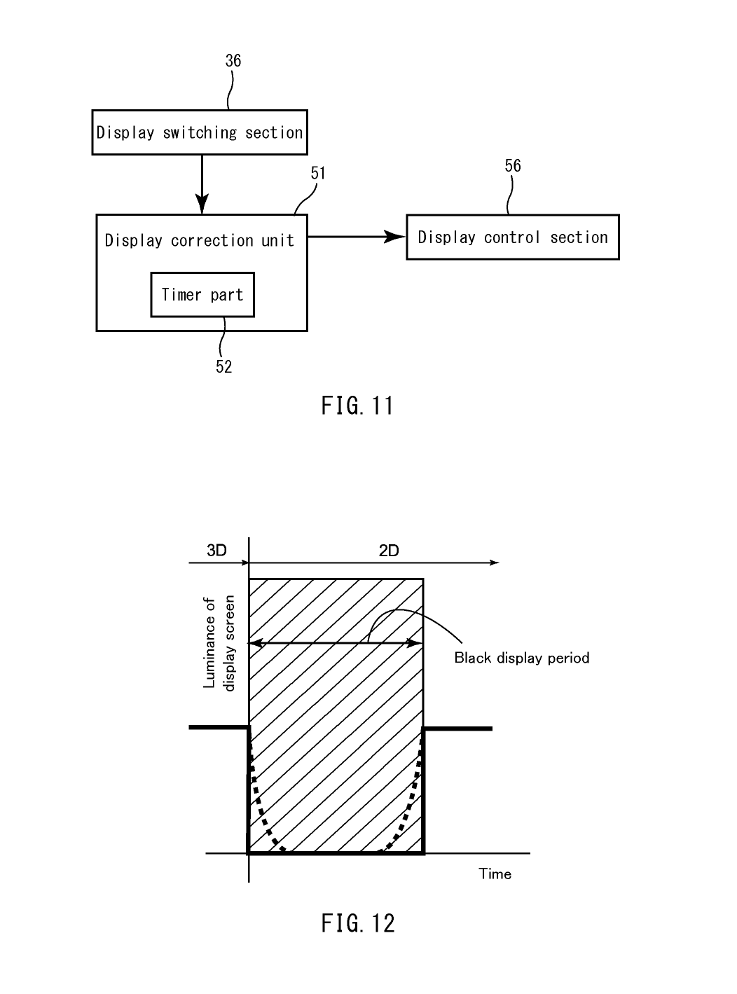

FIG. 11 shows a configuration for decreasing a sense of incongruity caused by luminance changes in the main panel 2 that occur upon the switching between the two-dimensional display and the three-dimensional display, in a liquid crystal display device according to Embodiment 2. As the basic configuration of the liquid crystal display device is identical to that of Embodiment 1 described above, explanation of the configuration of the liquid crystal display device is omitted herein.

Specifically, as shown in FIG. 11, the liquid crystal display device includes a display switching section 36 identical to that of Embodiment 1, a display correction unit 51 (vision correction unit) that outputs a correction signal for turning images into a black display state (black state) upon the display switching, and a display control section 56 that outputs an image data signal according to the correction signal. It should be noted that the liquid crystal display device also includes a luminance control section that outputs a control signal to the backlight control section 35, which is however not shown in the drawing.

The display control section 56 is configured so as to output image data signals for displaying images on the main panel 2, to a source driver that is not shown. The display control section 56, when receiving a correction signal from the display correction unit 51, generates an image data signal at a lower gray scale level (for example, a gray scale level of zero) according to the correction signal, and outputs the same. The image data signal output from the display control section 56 is input into a source driver that is not shown. This source driver generates a gray scale level display signal based on the image data signal thus input thereto, and outputs the gray scale level display signal. This gray scale level display signal is supplied to the pixels of the main panel 2 via source lines that are not shown. Thus, an image in the black state is displayed on the main panel 2.

The display correction unit 51, when receiving a signal indicating the switching between the two-dimensional display and the three-dimensional display from the display switching section 36, outputs a correction signal for performing the black display, to the display control section 56, so as to turn the image into the black display state. In other words, when the luminance fluctuates unnaturally upon the switching between the two-dimensional display and the three-dimensional display, this display correction unit 51 outputs a correction signal that causes an image data signal of a low gray scale level (e.g., a gray scale level of zero) to be output from the display control section 56. Further, the display correction unit 51 includes a timer part 52 that counts the time while the correction signal for the black display is being output. When a predetermined time from the start of output of the correction signal for the black display is counted by this timer part 52, the output of the correction signal is stopped in the display correction unit 51. Therefore, with the above-described configuration, it is possible to return the display to the normal image display after the black display of images is performed for a predetermined time continuously. The predetermined time is set to, or more than, the time of occurrence of luminance changes in the main panel 2 that would give a sense of incongruity to a viewer upon the switching between the two-dimensional display and the three-dimensional display. Further, the predetermined time may be set to the longest time among possible switching times of the switch panel 3 in the liquid crystal display device, or may be varied according to the ambient temperature.

This allows images to be in the black display state for a predetermined time, as indicated by hatching in FIG. 12, which makes it possible to prevent fluctuations of the luminance of the main panel 2 during the time of switching of the switch panel 3 from being viewed. Accordingly, it is possible to prevent luminance changes in the main panel 2 that would give a sense of incongruity upon the switching between the two-dimensional display and the three-dimensional display from being viewed by a viewer. It should be noted that the solid line in FIG. 12 indicates luminance changes in the display screen.

Further, the display correction unit 51 may be configured so as to perform both of the following, as indicated by the broken line in FIG. 12: the fade-out, i.e., gradually reducing the luminance of the display screen to achieve the black display state, when images are turned into the black display state; and the fade-in, i.e., gradually increasing the luminance of the display screen from the black display state to the original luminance level. It should be noted that the display correction unit 51 may be configured so as to perform either one of the fade-out and the fade-in.

In the present embodiment, the “black display” encompasses, not only the case where the luminance is completely nullified so that the display becomes completely black, but also the case where the luminance of the display screen is reduced to such a level that luminance changes in the main panel 2 upon the switching between the two-dimensional display and the three-dimensional display are not visible. In other words, in the present embodiment, the gray scale level of an image data signal output from the display control section 45 is not limited to the level of zero, but the image data signal may be a signal of a gray scale level for reducing the luminance of the display screen to such a level that luminance changes in the main panel 2 upon the switching between the two-dimensional display and the three-dimensional display are not visible.

### Effect of Embodiment 2

As described above, according to the present embodiment, images are turned into the black display state, upon the switching between the two-dimensional display and the three-dimensional display, for a period (a predetermined time) until unnatural luminance changes in the main panel 2 disappear. This makes it possible to prevent luminance changes that would give a sense of incongruity from being viewed by a viewer, upon the switching between the two-dimensional display and the three-dimensional display.

### Embodiment 3

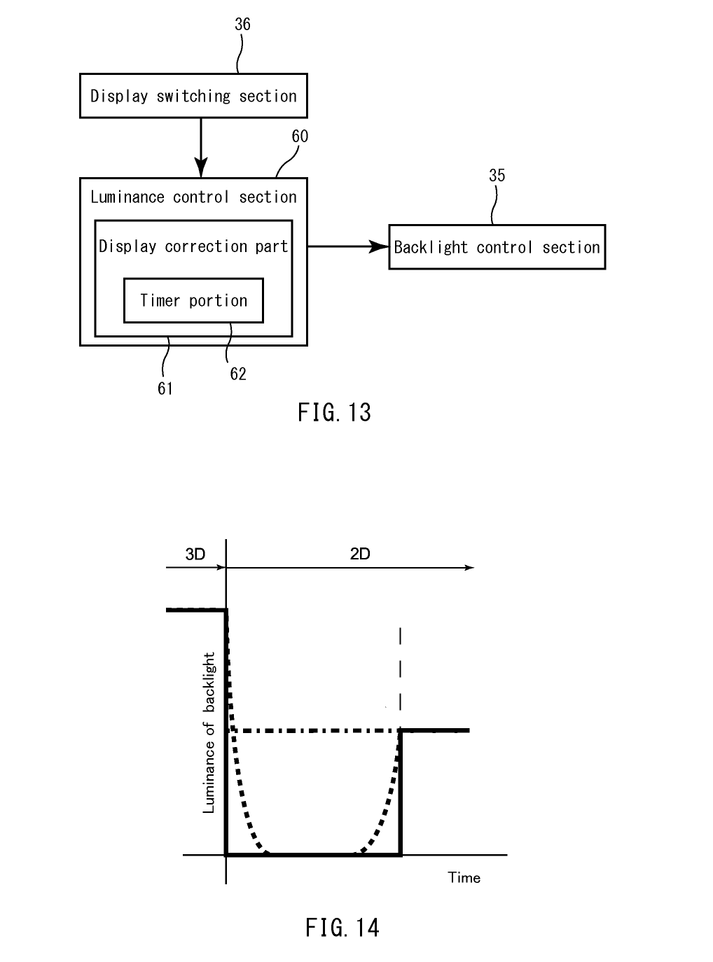

FIG. 13 shows a configuration for decreasing a sense of incongruity caused by luminance changes in the main panel 2 that occur upon the switching between the two-dimensional display and the three-dimensional display, in a liquid crystal display device according to Embodiment 3. The configuration of this embodiment is different from the configuration of Embodiment 2 in the point that the display control section in Embodiment 2 described above is a backlight control section, and the black display state is realized by changing the luminance of the backlight. As the basic configuration of the liquid crystal display device is identical to that of Embodiment 1 described above, explanation of the configuration of the liquid crystal display device is omitted herein. Besides, members that are identical to those in the configuration of Embodiment 2 described above are denoted by the same reference numerals, and explanation of the same is omitted herein.

Specifically, the liquid crystal display device according to the present embodiment includes a display switching section 36 identical to that in Embodiment 1, a luminance control section 60, and a backlight control section 35 that controls the backlight 7. The luminance control section 60 outputs a control signal to the backlight control section 35, based on a signal output by the display switching section 36. Further, the luminance control section 60 includes a display correction part 61 (vision correction unit) that reduces the luminance of the backlight 7, upon the switching between the two-dimensional display and the three-dimensional display, so that unnatural luminance changes in the main panel 2 should not be viewed.

The display correction part 61 includes a timer portion 62 that counts the time while the control signal is being output. When a predetermined time from the start of output of the control signal is counted by this timer portion 62, the output of the control signal form the display correction part 61 is stopped. Thus, the control signal can be output for a predetermined time, as is the case with Embodiment 2.

The control signal output from the display correction part 61 is a signal that causes the luminance of the backlight 7 to decrease, thereby causing the screen into the black display state. Therefore, when the backlight control section 35 receives this control signal, the screen of the liquid crystal display device turns black, and luminance changes in the main panel 2 upon the switching between the two-dimensional display and the three-dimensional display become hardly visible.

FIG. 14 shows luminance changes of the backlight 7 upon the switching from the three-dimensional display to the two-dimensional display. As indicated by the solid line in FIG. 14, luminance changes in the main panel 2 that occur due to the backflow phenomenon of the switch panel 3 are made hardly visible by causing the luminance of the backlight 7 to decrease for a predetermined time after the switching from the three-dimensional display to the two-dimensional display. It should be noted that the dashed-dotted line in FIG. 14 indicates a case where, upon the switching from the three-dimensional display to the two-dimensional display, the luminance of the backlight 7 is decreased when the two-dimensional display is performed, as compared with that when the three-dimensional display is performed, without correction of the luminance by the display correction part 61 as described above.

Further, the display correction part 61 may be configured so as to perform both of the following, as indicated by the broken line in FIG. 14: the fade-out, i.e., gradually reducing the luminance of the backlight 7 to achieve the black display state, when the screen is turned into the black display state; and the fade-in, i.e., gradually increasing the luminance of the backlight 7 from the black display state to the original luminance level. It should be noted that the display correction part 61 may be configured so as to perform either one of the fade-out and the fade-in.

In the present embodiment, the “black display” encompasses, not only the case where the backlight 7 is completely turned off, but also the case where the luminance of the backlight 7 is reduced to such a level that luminance changes in the main panel 2 upon the switching between the two-dimensional display and the three-dimensional display are not visible.

### Effect of Embodiment 3

With the configuration described above, according to the present embodiment, fluctuations of the luminance of the main panel 2 resulting from behaviors of liquid crystal in the switch panel 3 are made invisible by reducing the luminance of the backlight 7, upon the switching between the two-dimensional display and the three-dimensional display. This makes it possible to prevent luminance changes that would give a sense of incongruity to a viewer from occurring in the display screen upon the switching between the two-dimensional display and the three-dimensional display.

### Embodiment 4

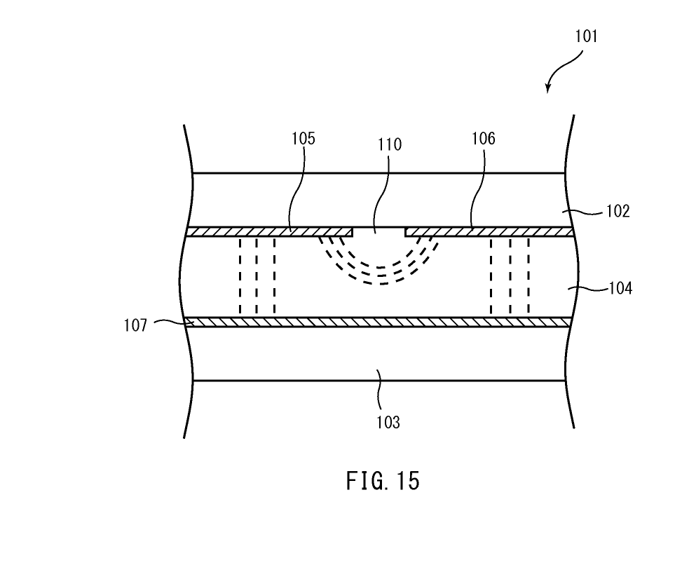

FIG. 15 shows a schematic configuration of a switch panel of a liquid crystal display device according to Embodiment 4. This configuration of Embodiment 4 is different from that of Embodiment 1 described above regarding the configuration of the switch panel. In the following explanation, only different portions are described, and descriptions about the portions common to the configuration of Embodiment 1 are omitted herein.

Specifically, as shown in FIG. 15, a switch panel 101 includes a pair of substrates 102 and 103 that are opposed to each other, and a liquid crystal layer 104 is provided between these substrates. On one of the substrates, i.e., the substrate 102, on a surface thereof on the liquid crystal layer 104 side, two first electrodes 105 and 106 are arranged with a clearance 110 therebetween. On the other substrate, i.e., the substrate 103, on a surface thereof on the liquid crystal layer 104 side, a second electrode 107 is formed.

In the configuration as described above, when a voltage is applied across the first electrodes 105, 106 and the second electrode 107, an electric field is formed between the first electrodes 105 and 106, in portions thereof close to the clearance 110 side, as shown in FIG. 15. It should be noted that, in portions farther from the clearance 110, electric fields vertical to the substrates 102 and 103 are formed between the first electrodes 105, 106 and the second electrode 107. In FIG. 15, the electric fields are shown with broken lines schematically for explanation. Further, in FIG. 15, cross sections of the substrates 102 and 103, and the liquid crystal layer 104 are shown, but hatching is omitted.

The electric fields as described above are formed between the substrates 102 and 103, whereby liquid crystal molecules are aligned according to the electric fields in the liquid crystal layer 104. This allows a so-called liquid crystal lens to be formed, in which different phase variations occur to incident light at different positions in the plane direction of the panel, respectively.

By causing the switch panel 101 to have the configuration as described above, a part of the liquid crystal layer 104 functions like an optical lens when electric fields are applied to the liquid crystal layer 104. Therefore, by causing a right-eye image and a left-eye image to be displayed on the switch panel 101, and causing the liquid crystal layer 104 to function as an optical lens, a left-eye image on the main panel 2 can be caused to reach the left eye, and a right-eye image on the main panel 2 can be caused to reach the right eye, by the liquid crystal layer 104. Accordingly, with the switch panel 101, it is possible to cause a two-dimensional image displayed on the main panel 2 to be viewed as a three-dimensional image by a viewer. On the other hand, when no electric field is applied to the liquid crystal layer 104 of the switch panel 101, an image on the main panel 2 as it is can be viewed as a two-dimensional image. It should be noted that the configuration of a display device for three-dimensional display, incorporating such liquid crystal lenses, is identical to the configuration of a usual device, and detailed explanation of the configuration is therefore omitted.

In the liquid crystal display device using the switch panel 101 that forms such liquid crystal lenses, the liquid crystal layer 104 of the switch panel 101 has a thickness that is significantly greater than the thickness of the liquid crystal layer of the switch panel that displays a stripe image as in Embodiment 1. Therefore, a switching time until the alignment of liquid crystal molecules in the liquid crystal layer 104 of the switch panel 101 switches is longer than that in the case of the configuration of Embodiment 1 described above. Even in such a configuration, by applying any one of the configurations of Embodiments 1 to 3, it is still possible to reduce luminance changes in the display screen upon the switching between the two-dimensional display and the three-dimensional display.

### Effects of Embodiment 4

As described above, in the present embodiment, the configuration of any of Embodiments 1 to 3 described above is applied in the liquid crystal display device including the switch panel 101 that forms the liquid crystal lenses. This makes it possible to prevent occurrence of luminance changes in the display screen that would give a sense of incongruity to a viewer upon the switching between the two-dimensional display and the three-dimensional display, even with the switch panel 101 having a configuration with a long switching time for the switching between the two-dimensional display and the three-dimensional display.

### Other Embodiments

So far the embodiments of the present invention have been explained, but the embodiments described above are merely examples for embodying the present invention. Therefore, the present invention is not limited to the embodiments descried above, and in embodying the present invention, any one of the above-described embodiments can be modified appropriately as long as it does not go beyond the spirit of the invention.

In each of the above-described embodiments, a TN-type liquid crystal panel is used as the switch panel 3. The switch panel, however, may be a STN liquid crystal panel or a liquid crystal panel of another type, or alternatively, a panel in any configuration as long as it is a display panel that can be switched between the two-dimensional display and the three-dimensional display.

In each embodiment, the present invention is applied to a liquid crystal display device. However, the configuration is not limited to this, and the present invention may be applied to a display device of another type, such as an organic EL. It should be noted that in the case where the main panel is formed with an organic EL, the main panel itself doubles as a light source section.

### INDUSTRIAL APPLICABILITY

The display device of the present invention can be used as a display device including a switch panel that is capable of switching the display of images between two-dimensional display and three-dimensional display.

1. A display device comprising:
a main panel that displays an image;
a switch panel arranged to be opposed to the main panel, the switch panel being capable of switching a mode between a two-dimensional mode that causes an image displayed on the main panel to be viewed as a two-dimensional image and a three-dimensional mode that causes the image to be viewed stereoscopically;
a luminance control section that changes a luminance of the main panel upon mode switching by the switch panel; and
a vision correction unit that makes a luminance change in the main panel hardly visible on a viewing side upon mode switching by the switch panel.

2. The display device according to claim 1, wherein the vision correction unit is configured to change the luminance of the main panel, so as to make a luminance change in the main panel hardly visible from the viewing side upon mode switching by the switch panel.

3. The display device according to claim 2, further comprising a light source section for emitting light to the main panel,
wherein the vision correction unit is configured to change a luminance of the light source section.

4. The display device according to claim 2,
wherein the vision correction unit is configured to adjust the luminance of the main panel so as to cause a display screen viewed from the viewing side to have a constant luminance upon mode switching by the switch panel.

5. The display device according to claim 2,
wherein the vision correction unit includes:
a temperature detection part that detects an ambient temperature;
a correction value storage part in which a correction value for correcting the luminance of the main panel according to the ambient temperature is stored; and
a luminance correction section that, according to the ambient temperature detected by the temperature detection part, reads out the correction value stored in the correction value storage part, and corrects the luminance of the main panel by using the correction value.

6. The display device according to claim 2,
wherein the vision correction unit includes:
a luminance detection part that detects a luminance of the display screen on the viewing side; and
a luminance adjustment part that adjusts the luminance of the main panel based on the luminance detected by the luminance detection part.

7. The display device according to claim 1,
wherein the vision correction unit is configured to change a gray scale level of an image displayed on the main panel, so as to make a luminance change in the main panel hardly visible from the viewing side.

8. The display device according to claim 2,
wherein the vision correction unit is configured to turn the display screen into a black state, so as to make a luminance change in the main panel invisible from the viewing side, upon mode switching by the switch panel.

9. The display device according to claim 8,
wherein the vision correction unit is configured to, when turning the display screen into the black state, gradually decrease the luminance of the main panel to turn the display screen into the black state, and thereafter gradually increase the luminance of the main panel.

10. The display device according to claim 1,
wherein the switch panel includes a liquid crystal layer, and a pair of electrodes arranged so that the liquid crystal layer is interposed between the electrodes.

11. The display device according to claim 10,
wherein, when a voltage is applied to the pair of electrodes of the switch panel, the liquid crystal layer of the switch panel functions as a liquid crystal lens.
